(19) United States
(12) Patent Application Publication
(10) Pub. No.: US 2014/0157882 A1
(43) Pub. Date: Jun. 12, 2014

(54) DISTRIBUTED TEMPERATURE SENSING WITH BACKGROUND FILTERING

(71) Applicant: Menno Mathieu Molenaar, Calgary (CA)

(72) Inventor: Menno Mathieu Molenaar, Calgary (CA)

(21) Appl. No.: 14/233,343

(22) PCT Filed: Jul. 12, 2012
(86) PCT No.: PCT/US2012/046339

§ 371 Date: Jan. 16, 2014

Related U.S. Application Data
(60) Provisional application No. 61/508,936, filed on Jul. 18, 2011.

(51) Int. Cl. E21B 47/06; G01V 9/00

(52) U.S. Cl. CPC E21B 47/065; G01V 9/005
USPC 73/152.12

(57) ABSTRACT

A method for determining information about points in a wellbore that includes a region of interest comprises a) providing a first set of measured temperature data corresponding to a comparison portion of the wellbore that is not in the region of interest and a second portion of the wellbore that is in the region of interest, b) providing a second set of measured temperature data also corresponding to the comparison and second portions of the wellbore, c) on a microprocessor, using the comparison portions of the first and second data sets to align the first and second data sets, d) subtracting the second portion of the first data set from the portion of the second data set with which it is aligned, and e) outputting the result of step d) as human-readable information about points in the region of interest.

### RELATED CASES

Not applicable.

### FIELD OF THE INVENTION

The invention relates to a method for making distributed temperature measurements in a borehole and in particular to a system for removing a background signature from data generated by a fiber optic temperature sensing system.

### BACKGROUND OF THE INVENTION

Hydrocarbon production from underground formations often includes one or more of a variety of well treatment techniques intended to increase the amount of marketable hydrocarbons that flow out of a well. One such technique is hydrofraccing, in which a fracture fluid is pumped down the wellbore and out into the hydrocarbon-containing layers of the formation. The fracture fluid is injected at sufficiently high pressure that it fractures, or “fracs,” the formation. The frac fluid usually contains mostly water, plus chemicals selected to enhance the flow of hydrocarbons and/or solid particles that become wedged in the fractured formation. In either case, the objective is to enable the formation to produce more hydrocarbons once the fraccing process is complete.

Because it is difficult to determine very precisely what is happening in an active wellbore, it is common to seek information about the temperature at various points in the wellbore. By way of example only, it is often desirable to gain information about the success and efficiency of a perforating job, or of a fraccing job. This information may be ascertained by detecting and/or measuring the flow of formation fluid into the wellbore. If the temperature is detected at several points in the borehole, a temperature profile can be obtained. The more closely the points are spaced, the more detailed the temperature profile will be.

If the fluid pumped into the borehole during fraccing, i.e. the “frac fluid,” is cooler or warmer than the formation, the flow of frac fluid into the surrounding formation will result in localized cooling or warming in the immediate vicinity of each fracture. Thus, a sufficiently detailed temperature profile can be used to determine the success of a frac job.

Various techniques for using temperature to detect and/or measure the flow of formation fluid into the borehole have been proposed. Among such techniques is distributed temperature sensing (DTS), in which an optical fiber is deployed in the wellbore and is connected to a lightbox that transmits optical pulses into the optical fiber and receives reflected signals back from the optical fiber. By measuring the timing and phase of the returned signals, information about the temperature at points along the fiber can be obtained.

Because the temperature of the injected fluid is typically significantly different from the ambient downhole temperature(s), the beginning of an injection process will cause a transition in the temperature at each point in the well as the temperature at each point changes from its initial, pre-injection temperature to a new steady-state temperature. The time required for each point to attain its new steady-state temperature depends on the degree of thermal coupling between that point and its surroundings and the thermal properties of that point. The more effectively a point is thermally coupled to the fluid flow, the more quickly that point will attain the new steady-state temperature.

In many instances, the measured steady-state temperatures are processed according to a pre-conceived well model. The thermal characteristics of thermal decays and amplitudes are predicted based on phenomena expected from that well model. In such instances, the wellbore temperature profile is typically assumed to be a smooth line, i.e. steady state, with the only variations occurring due to predicted wellbore phenomena such as water-injection, fluid inflow, or lift-gas injection. The measured temperature for a specific wellbore event is then correlated or matched with the well model to calculate, for example, flowrates or inflow or outflow profiles.

It is known, however, that such models do not match reality very well, particularly early in the injection process. For instance, temperatures measured using a fiber clamped to a production casing and measured during an injection process are not a smooth line. Many of the variations in measured temperatures are attributable to variations in the thermal coupling of the cable to the tubing or casing. Variations in thermal coupling can be caused by the presence of the fiber clamps, proximity of the borehole wall, variations in cement quality, variations in thermal properties of its surroundings etc. Because the degree of thermal coupling between the temperature sensors and their environment varies significantly along the wellbore, it is difficult to use the measured temperatures at each point in the well to distinguish the actual localized temperature changes during the fracturing operation that are caused by the injection of the fluid into the formation from the temperature changes occurring as a result of the wellbore cooling from its initial, pre-injection temperature to a new steady-state temperature.

In addition, it is frequently desirable to obtain information about a well treatment process in less time than it takes for the temperatures in the well to attain steady-state.

For these reasons, a method for making a meaningful distributed temperature measurement that does not depend solely on modeling and can be performed concurrently with a well treatment process would provide advantages over the state of the art.

### SUMMARY OF THE INVENTION

In accordance with preferred embodiments of the invention there is provided a method for making distributed temperature measurement that does not depend solely on modeling. In preferred embodiments, the invention includes a method for determining temperature at points in a wellbore that includes a region of interest, comprising the steps of a) providing a first set of measured temperature data corresponding to a comparison portion of the wellbore that is not in the region of interest and a second portion of the wellbore that is in the region of interest, b) providing a second set of measured temperature data also corresponding to the comparison and second portions of the wellbore, c) on a microprocessor, using the comparison portions of the first and second data sets to align the first and second data sets, d) subtracting the second portion of the first data set from the portion of the second data set with which it is aligned, and e) outputting the result of step d) as human-readable information about temperature at points in the region of interest.

The region of interest may include a perforation and a fluid inflow or outflow. The first set of measured temperature data may be collected when said fluid inflow or outflow is not occurring and the second set of measured temperature data may be collected during injection of a fraccing fluid. The first and second sets of measured temperature data may each be collected during a thermal transition, more preferably during the first 30 minutes following the start of a thermal transition in the wellbore, and still more preferably during the first 5 minutes following the start of a thermal transition in the wellbore.

The result of step d) may be output as human-readable information about the temperature at points in the region of interest or as as human-readable information about the flow rates into or out of the well at points in the region of interest. In the latter case, step e) may include i) removing at least a portion of the signal that is not related to flow, ii) assessing flow regimes across depths and times, iii) calculating axial flow within the wellbore using known relationships for axial flow, iv) calculating flow rates into or out of the wellbore at one or more points using known relationships for flow through an orifice, and v) outputting the calculated flow rates as human-readable information.

The first and second sets of measured temperature data may be collected using a fiber optic temperature sensor or other temperature sensor.

As used in this specification and claims the following terms shall have the following meanings: the terms “above” and “below” refer to positions that are closer to the top or bottom, respectively, of the borehole.

### BRIEF DESCRIPTION OF THE DRAWINGS

For a more detailed understanding of the invention, reference is made to the accompanying FIGS., in which:

FIG. 1 is a schematic illustration of the concepts disclosed herein;

FIG. 2 is a schematic illustration of the system of FIG. 1 during a later stage in the

disclosed process; and

FIG. 3 is an annotated plot showing data such as may be used in the present invention.

### DETAILED DESCRIPTION OF A PREFERRED EMBODIMENT

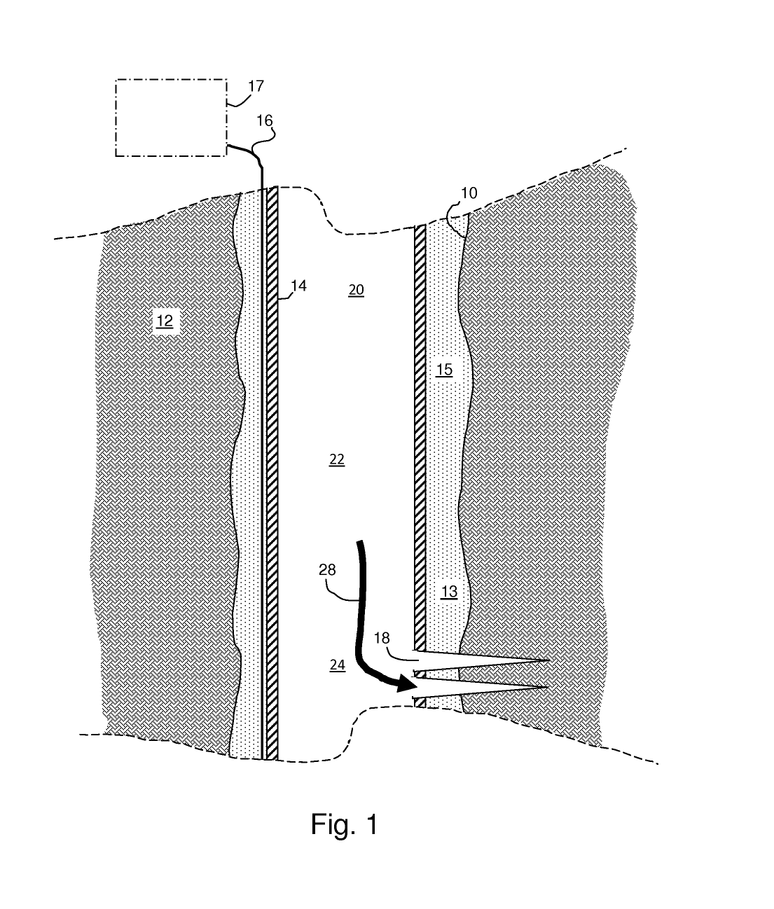

Referring briefly to FIG. 1, a wellbore 10 is drilled in a formation 12. To prevent wellbore 10 from collapsing and/or to otherwise line or reinforce wellbore 10, wellbore 10 includes a string of casing 14 that is inserted and cemented in wellbore 10. Cement 13 is pumped up an annulus 15 between casing 14 and the wall of wellbore 10 to provide a bonded cement sheath that secures casing 14 in wellbore 10.

In preferred embodiments, a temperature sensor comprising an optical fiber 16 is provided in the well. It will be understood that fiber 16 may be any suitable fiber and may be deployed and positioned in the well in any suitable manner. In other embodiments, the temperature sensor is not an optical fiber, but may be other temperature sensing means, such as string of thermocouples or the like. Fiber or sensor 16 is preferably connected at the surface to a a signal transmitting and receiving means and to a data collection means, such as a microprocessor, both of which are known in the art and shown in phantom at 17.

Still referring to FIG. 1, during an initial phase of the inventive method, a portion of the well may be perforated, as illustrated at 18. In the embodiment shown, wellbore 10 may thus be characterized as having three sections, namely a first section 20, which is uppermost and is not perforated or fractured, a second section 22, which is below section 20 and is not initially perforated or fractured, and a third section 24, which is below section 22 and is perforated. Fluids pumped into the well during this phase will flow out into the formation via perforations 18, as indicated generally by arrow 28.

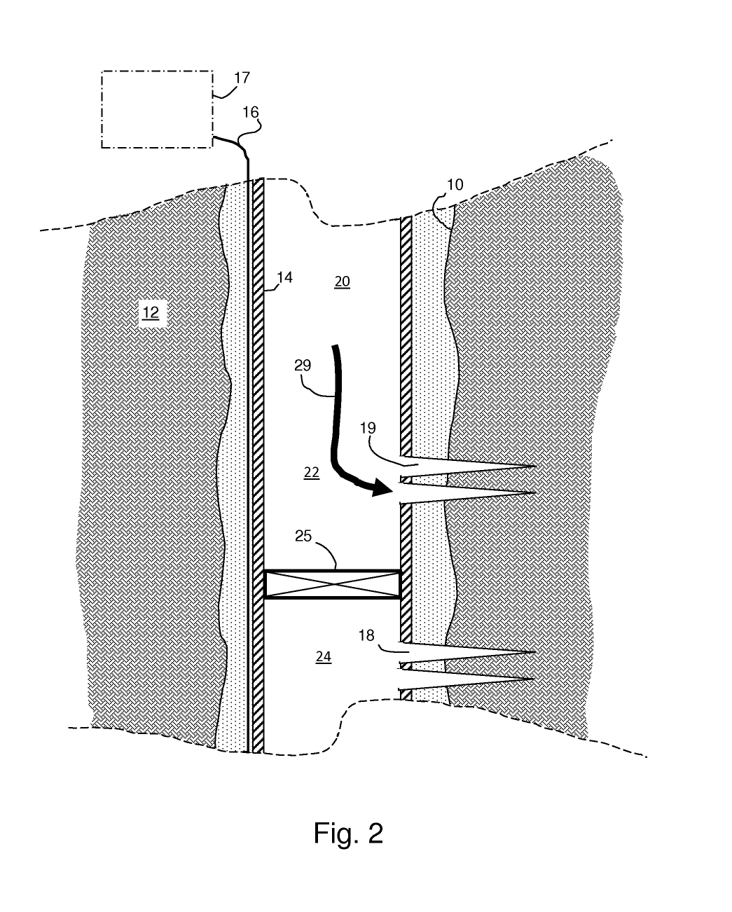

Referring now to FIG. 2, during a second phase of the inventive method, section 24 has been isolated from sections 20 and 22, preferably by means of a packer 25, and section 22 has been perforated, as illustrated at 19. Fluids pumped into the well during this phase will flow out into the formation via perforations 19, as indicated generally by arrow 29.

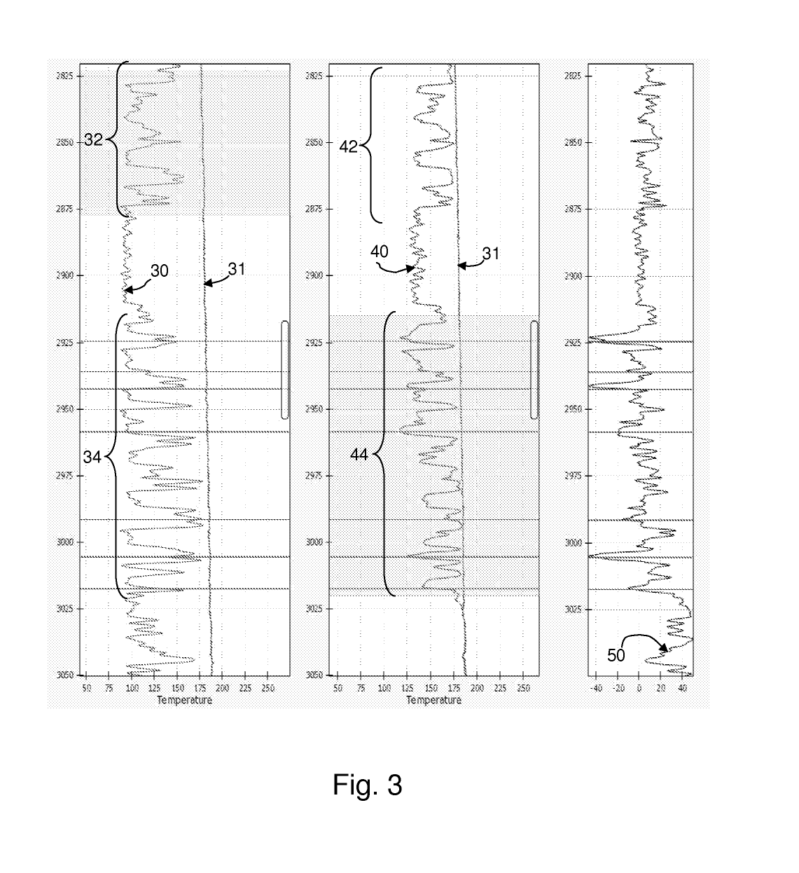

Referring now to FIG. 3, traces 30, 40 illustrate typical distributed temperature measurements taken in a wellbore during fraccing operations and traces 31 illustrate the measured ambient geothermal temperature taken before any fluid injection has occurred. Traces 30, 31 are taken during the initial phase, illustrated in FIG. 1, during which section 22 is not perforated, and trace 40 is taken during the second phase, illustrated in FIG. 2, during which section 22 is perforated.

In both traces, fluid is flowing into or out of the well; in trace 30, fluid is flowing through perforations 18 and in trace 40 fluid is flowing through perforations 19. The injected fluid can be a frac fluid or it may be any other fluid flowing through the well.

Each trace 30, 40 can be divided into a first section, 32, 42, respectively and a second section, 34, 44, respectively. First sections 32, 42 measure the temperature distribution in a section of the wellbore that is not fracced, such as upper section 20 in FIGS. 1 and 2, while second sections 34, 44, measure the temperature distribution in a section of the wellbore in which it is desirable to monitor fraccing, such as section 22 in FIGS. 1 and 2.

According to preferred embodiments of the present invention, an output that is indicative of the extent of fraccing in section 22 can be obtained by subtracting trace 30 from trace 40. In preferred embodiments, each trace is selected to correspond to a similar stage in a thermal transition within the well. Still more preferably, each trace is selected to correspond to the beginning of a thermal transition within the well, i.e. a period during which the thermal profile of the well begins a transition from one steady state to another steady state. Thus, for example, data obtained during the start of fraccing of a lower section of the well, e.g. section 24, can be subtracted from data obtained during the start of fraccing in an upper section of the well, e.g. section 22. The result will be an output of temperature variations attributable to fraccing and not to thermal coupling.

As illustrated by trace 50 in FIG. 3, the output trace will contain less noise and will be an effective tool for assessing fraccing in- or outflows or other localized thermal phenomena. Because it can be used with data obtained before the transition to the new steady state has been reached, the present invention allows information about a fraccing operation to be obtained much more quickly. Since many fracturing operations take less time than is required for the well to attain a new steady state temperature, the present method allows a much more accurate indication of the thermal state of the well.

It will be understood that the data used to generate each trace 30, 40 can originate as one or more raw DTS datasets collected during the relevant fraccing stage. In one embodiment, a single DTS trace from each fraccing stage is selected. The selection is preferably based on comparison of a trace from the current fraccing stage with the available traces from the previous fraccing stage, in order to select a pair for which upper trace sections 32, 42 give the best match.

In some embodiments, it may be desirable to process the data before subtracting the datasets. In particular, the data in each trace corresponding to an un-fracced section(s) of the well can be compared and the fit between corresponding un-fracced sections of the well can be optimized and applied to each trace in order to ensure maximum depth correlation between the two traces. The optimization process may include stretching or compressing one of the traces or datasets, and/or shifting one of the datasets up or down. If desired further enhancement of the results may be obtained by using an average of 2 or more datasets taken during each fraccing stage. The averaged datasets may span a period of time beginning at or near the start of a thermal transition and lasting up to 30 minutes and more preferably less than 5 minutes. By way of example only, an average data collection setup will produce about two DTS traces per minute and an average fracturing operation may last up to about 3 hours per stage, so in some instances there may be several traces available from which to select and/or produce averages.

The sensing fiber is preferably installed external to the production conduit, proving an unrestricted flow conduit for well interventions/stimulations and production, but may be also positioned or deployed on other positioning tools such coiled tubing, tubing or wireline. The fiber cable is preferably positioned behind the production casing or production liner and extends at least across the treatment intervals. The installation of the cable is preferable carried out while completing the wellbore in running the casing or liner across the treatment intervals. The wellbore may include a horizontal portion and the present invention may be carried out in the horizontal portion.

In embodiments where it is desired to use the temperature information to obtain information about flow into or out of the well at points in the well, the method may also include removing at least a portion of the signal that is not related to flow, assessing flow regimes across depths and times, calculating axial flow within the wellbore using known relationships for axial flow, calculating flow rates into or out of the wellbore at one or more points using known relationships for flow through an orifice, and outputting the calculated flow rates as human-readable information

While a preferred embodiment of the invention has been shown and described, it will be understood that variations and modifications may be made without departing from the scope of the invention, which is set out in the claims that follow. In particular, the thermal data may be from any downhole source, or from a model; the sensors may be fiber optic or other sensors, the thermal phenomena that are detected may be attributable to fraccing or other completion operations, and the like.

1. A method for determining information about points in a wellbore that includes a region of interest, comprising the steps of :
a) providing a first set of measured temperature data corresponding to a comparison portion of the wellbore that is not in the region of interest and a second portion of the wellbore that is in the region of interest;
b) providing a second set of measured temperature data also corresponding to the comparison and second portions of the wellbore;
c) on a microprocessor, using the comparison portions of the first and second data sets to align the first and second data sets;
d) subtracting the second portion of the first data set from the portion of the second data set with which it is aligned; and
e) outputting the result of step d) as human-readable information about points in the region of interest.

2. The method according to claim 1 wherein the region of interest includes a fluid inflow or outflow and wherein the first set of measured temperature data is collected when said fluid inflow or outflow is not occurring.

3. The method according to claim 2 wherein the region of interest includes a perforation and the second set of measured temperature data is collected during injection of a fraccing fluid.

4. The method according to claim 1 wherein the first set of measured temperature data is collected during a thermal transition.

5. The method according to claim 4 wherein the second set of measured temperature data is collected during a thermal transition.

6. The method according to claim 1 wherein the first and second sets of measured temperature data are collected during the first 30 minutes following the start of a thermal transition in the wellbore.

7. The method according to claim 1 wherein the first and second sets of measured temperature data are collected during the first 5 minutes following the start of a thermal transition in the wellbore.

8. The method according to claim 1 wherein step e) includes outputting the result of step d) as human-readable information about the temperature at points in the region of interest.

9. The method according to claim 1 wherein step e) includes:
i) removing at least a portion of the signal that is not related to flow,
ii) assessing flow regimes across depths and times,
iii) calculating axial flow within the wellbore using known relationships for axial flow,
iv) calculating flow rates into or out of the wellbore at one or more points using known relationships for flow through an orifice, and
v) outputting the calculated flow rates as human-readable information.

10. The method according to claim 1 wherein the first and second sets of measured temperature data comprise the output of a fiber optic temperature sensor.
